(19) United States
(12) Patent Application Publication
(10) Pub. No.: US 2019/0032704 A1
(43) Pub. Date: Jan. 31, 2019

(54) JOINT THAT IS FIXABLE IN REGULARLY SPACED-APART POSITIONS, AND COMPONENT ASSEMBLY HAVING SUCH A JOINT

(71) Applicant: WITTE BARSKAMP KG, Bleckede (DE)

(72) Inventor: Andreas WITTE, Lüneburg (DE)

(21) Appl. No.: 16/082,292

(22) PCT Filed: Feb. 23, 2017
(86) PCT No.: PCT/EP2017/054154

§ 371 Date: Sep. 5, 2018

(30) Foreign Application Priority Data
Mar. 14, 2016 (DE) 20 2016 101 401.8

(51) Int. Cl. F16C 11/10; F16B 7/04; F16B 7/18

(52) U.S. Cl. CPC F16C 11/10; F16B 7/18; F16B 7/048

(57) ABSTRACT

A joint fixable in a plurality of joint positions selected according to a first position pitch subdivided into equal spacing steps in a direction of joint movement. The joint has two joint parts displaceable relative to and bearing against one another by way of joint faces. A first joint face on a first joint part is provided with structuring having a second position pitch subdivided into equal spacing steps in the direction of joint movement. The structuring creates latch engagement points distributed at the second position pitch. A second joint face on a second joint part has latch receptacles interrupting the second joint face at latch positions arranged at a third position pitch subdivided into equal spacing steps in the direction of the direction of joint movement. A locking element is introducible into one of the latch receptacles.

### TECHNICAL FIELD

This invention relates to a joint that is fixable in a plurality of joint positions that are selectable in accordance with a first position pitch subdivided into equal spacing steps in a direction of joint movement, said joint having two joint parts that are displaceable relative to one another and bear against one another by way of joint faces.

### BACKGROUND

### Background Information

It is known that for clamping workpieces, particularly three-dimensional workpieces having a complex shape, such as for example, in automobile manufacturing, doors, fenders, side parts, hoods, tailgates, and the like, appropriate clamping devices are formed for clamping or positioning such workpieces at clearly defined abutment points or support points, particularly for measuring purposes. Such clamping devices must be individually adjusted to the shape of the workpiece to be clamped, they are typically constructed like scaffolding from individual elements in the form of struts and plates and equipped with abutment means or clamping means in accordance with the abutments points in space. Examples of systems for such a modular design and clamping devices formed therefrom are described in EP 222 147 A2 and also in EP 1 640 621 A1. The modular systems shown there and the devices built from them are characterized in that the individual elements of the modular system are provided with connecting structures, there in the form of mounting holes, which are arranged and distributed across the surfaces of the associated elements at a predetermined pitch. This pitch and the connecting structures arranged therein already provide a high measure of freedom when it comes to positioning the elements relative to one another and to connect them. At the same time, the pitch defines a dedicated grid, such that positions which are close to each other in space cannot always be reached by such components having connecting elements which are arranged in a grid.

Accordingly, further efforts are required for the final positioning of clamping elements or abutment pieces to get the abutment member or clamping device to the exact abutment point, starting from a point in space near the abutment point reached during the assembly of the components of the modular system when building the clamping device using the available grid. In fixture construction, when respective clamping devices are assembled from prior art modular systems, adapter pieces made specifically for the respective design of the clamping device and the geometry to be achieved are frequently used. But this is mostly unsatisfactory due to the great effort building such a device requires, in that unique custom-built parts must be designed and manufactured.

An approach that results in an adjustment option can be seen in the device for fine adjustment of stops described in EP 1 080 830 A1. The device disclosed there allows axial fine adjustment along three axes oriented perpendicular to one another and an additional angle adjustment by an articulated design of individual elements of the disclosed device and its pivotability about either one of two mutually perpendicular pivoting axes. The device disclosed in EP 1 080 830 A1 thus implements various joints, namely, rotary joints for pivoting components and slide joints for axial adjustment of the involved components relative to one another. A device as disclosed in this specification makes it possible, starting from a point in space reached by utilizing the pitch on the components involved, at which point a component having a connector surface is disposed, to exactly align the actual abutment point by means of fine adjustment with respect to the axial setting of three independent spatial axes and with respect to an angular setting relative to the two mutually perpendicular pivoting axes, which allows considerably finer adjustment than would be possible with the pitch on the components alone and assembly of a device relying just on these components.

The device shown in EP 1 080 830 A1 however has a disadvantage in that it only allows limited degrees of freedom with respect to an angular adjustment of the rotary joints involved, on the one hand, and in that it does not include any other pitch, such that adjustment of the correct position of the abutment point needs to be performed manually and cannot be easily reproduced. This device also does not allow the setting of an offset bridging the pitch, since the actuating paths are very limited.

### SUMMARY

This is where the present invention comes into play, in that it provides a joint connection or a respective joint used particularly in conjunction with component parts or component assemblies for building clamping devices for workpieces, which allows a joint position to be set in a regular subdivision with equal, but nevertheless sufficiently narrow spacing steps using simple and robust means, and is easy for a user to operate.

This object is achieved, according to the invention, by a joint that is fixable in a plurality of joint positions that are selectable in accordance with a first position pitch subdivided in equal spacing steps in a direction of joint movement, said joint having two joint parts that are displaceable relative to one another and bear against one another by way of joint faces, wherein formed on a first joint part is a first joint face which is provided with structuring that has a second position pitch subdivided into equal spacing steps in the direction of joint movement. This arrangement creates latch engagement points that are distributed at the second position pitch. A second joint part has a second joint face and is provided with latch receptacles which interrupt the second joint face at latch positions that are arranged at a third position pitch subdivided into equal spacing steps in the direction of the direction of joint movement. The second and the third position pitch are each larger than the first position pitch. The first position pitch is determined by the amount of the difference between the second and the third position pitch. A locking element is introducible selectively into one of the latch receptacles in a joint position taken up along the direction of joint movement of the joint such that, from the latch position belonging to the latch receptacle, said locking element acts in such a way on a latch engagement point positioned with respect to the latch position in the joint position taken up that said locking element locks the joint in the joint position taken up.

Advantageous embodiments of such a joint include that the structuring of the first joint face is a toothing. The structuring of the first joint face is formed by holes drilled into the first joint part transversely to the first joint face according to the second position pitch. The latch receptacles are formed by holes terminating in the second joint face according to the third position pitch. The holes terminating in the second joint face penetrate through the second joint part. The joint is a rotary joint in which the two joint parts can be rotated relative to one another about a rotational axis, and in that the first, second, and third position pitches each are an angular pitch. The joint faces have the shape of a circular cylinder or circular cylinder section. The first joint face is a convex joint face and the second joint face is a concave joint face. The joint may be a slide joint in which the two joint parts can be moved linearly relative to one another in a direction of joint movement. The first, second, and third position pitches each are a spacing pitch.

Another aspect of the solution according to the invention is in a component assembly to be used for building a clamping device for workpieces in that said component assembly comprises a joint for setting and fixing an orientation of connecting points to be positioned in the device using the component assembly.

Preferred embodiments of such a component assembly include that said component assembly has the form of an abutment member comprising a base for connecting with a structural member of the clamping device and a connecting part for an abutment or clamping element, and settable at an angle, for forming a workpiece support in the clamping device, wherein at least one joint formed as a rotary joint between the base and the connecting part. The component assembly can comprise a central member between the base and the connecting part, which is coupled to the base by means of a first rotary joint comprising a first rotational axis and coupled to the connecting part by means of a second rotary joint comprising a second rotational axis oriented perpendicular to the first rotational axis. The first rotary joint is a rotary joint freely rotatably settable through 360°. The second rotary joint is a rotary joint whose pivoting angular range has limited rotatable setting options. The joint formed between two elements of the component assembly, which form the joint parts, is a slide joint wherein a linear offset between the two elements of the component assembly can be defined by means of the joint positions which can be set in accordance with the first spacing pitch.

According to the invention, a joint that is fixable in a plurality of joint positions that are selectable in accordance with a first position pitch subdivided into equal spacing steps in a direction of joint movement thus comprises two joint parts that are displaceable relative to one another and bear against one another by way of joint faces. A first joint face formed on the first joint part is provided with a second position pitch subdivided into equal spacing steps in the direction of joint movement, which creates latch engagement points that are distributed at the second position pitch. A second joint part has a second joint face and is provided with latch receptacles which interrupt the second joint face at latch positions that are arranged at a third position pitch subdivided into equal spacing steps in the direction of the direction of joint movement. In a manner significant to the invention, the second and the third position pitch are each larger than the first position pitch, wherein the first position pitch is determined by the amount of the difference between the second and the third position pitch. A locking element can be introduced selectively into one of the latch receptacles in a joint position taken up along the direction of joint movement of the joint, such that, from the latch position belonging to the latch receptacle, said locking element acts in such a way on a latch engagement point positioned with respect to the latch position in the joint position taken up that said locking element locks the joint in the joint position taken up.

The joint according to the invention, which in principle can be any within a broad technical definition of a joint, for example a rotary joint or a slide joint, therefore has a first position pitch with respect to the joint positions to be fixed which can be a very fine position pitch, due to the special selection of the second and third position pitches. If the difference between the second and the third position pitches is sufficiently small, a respectively small or fine first position pitch results, wherein the second and third position pitches can be comparatively wide. In other words, respective structures, that is, the structuring and the latch receptacles which penetrate the second joint face at the latch positions, can be produced with a comparatively wide position pitch obtainable as part of manufacturing and processing the joint parts involved, and still a very fine first position pitch can be achieved for the individual joint positions to be actuated separately for blocking. If the joint is implemented as a rotary joint, for example, the second position pitch can be an angular pitch with 10° steps, the third position pitch can be an angular pitch with 10.5° steps, such that the resulting angular pitch for the first position pitch is an angular pitch with 0.5° steps, that is, a very fine angular pitch.

It should be noted at this point that the joint according to the invention does not necessarily have to be intended for a permanent use as a joint, that is, with joint parts that can be moved relative to one another. Instead, the joint can also be used in such a manner that the joint function is utilized for a one-time setting of the joint position, for example two joint parts are linearly moved relative to one another (slide joint) or two joint parts are rotated relative to one another (rotary joint), and that this joint position is then fixed by blocking the joint parts and fixing them relative to one another in a reproducible manner as described above. A joint in the meaning of the invention is implemented by two elements which form the joint parts and which can be moved relative to one another in any manner and with some guidance in a direction of joint movement. Such guidance can for example be achieved by a respective shaping of the joint faces.

The position pitches (first, second, and third position pitches) can differ in nature depending on the type of joint. Particularly, the position pitches of slide joints are spacing pitches, the position pitches of rotary joints are angular pitches. The only significant feature is that the position pitch is subdivided into equal spacing steps, i.e. that adjacent positions each take an equal positional spacing relative to one another, for example an equal longitudinal spacing or an equal angular difference.

The structuring of the first joint face can for example be formed by a toothing. In such a toothing, the latch engagement points are for example formed by tooth bottoms which are disposed between two teeth and the spacing of which is the measure for the second position pitch. Alternatively, the structuring of the first joint face can also be formed by holes drilled at the spacing of the second position pitch transversely to the first joint face into the first joint part. These holes then also form respective latch engagement points in which a locking pin or the like can engage, for example.

The latch receptacles in the second joint part can for example be formed by holes terminating in the second joint face after the third position pitch. The holes themselves are not necessarily spaced from one another in accordance with the third position pitch. What matters is that the orifices of the holes in the second joint face have a spacing in accordance with the third position pitch. Such holes terminating in the second joint face can particularly penetrate through the second joint part, such that a locking element can be introduced from an opening of the hole located on a side opposing the second joint face. Such a locking element can for example be a locking pin as mentioned above, a self-tapping locking screw, or an element formed only after an introduced material, such as a liquid metal, a synthetic resin or the like, has hardened or solidified.

If the joint according to the invention is designed as a rotary joint, the joint faces may particularly have the shape of a circular cylinder or a circular cylinder portion. Particularly, the first joint face can be a convex joint face, the second joint face can be a concave joint face.

As mentioned above, the invention also relates to a component assembly to be used for building a clamping device for workpieces. This component assembly is characterized in that it comprises a joint of the design described above for setting and fixing an orientation of connecting points to be positioned in the device using the component assembly. Such a component assembly, which may for example be equipped on at least one connecting surface with fastening elements, such as mounting holes, arranged in a grid, which can also be combined with another component assembly according to the invention to obtain more degrees of freedom for adjustment, can now be used to adjust the joint position in accordance with the fine steps of the first position pitch to be able to set the position and orientation of a connecting point in space more accurately and precisely in clearly defined steps. Such a connecting point in space can for example be a point at which another intermediate member, i.e. another element for building the clamping device, is arranged and fixed. An abutment member or clamping element used for positioning or clamping a workpiece can also be arranged directly at the connecting point.

A component assembly according to the invention can particularly have the form of an abutment member comprising a base for connecting with a structural member of the clamping device and a connecting part for an abutment or clamping element, and settable at an angle, for forming a workpiece support in the clamping device. At least one joint configured as a rotary joint is then provided between the base and the connecting part in accordance with the aspect of the invention described above. Such a component assembly with a rotary joint can particularly comprise a central member between the base and the connecting part, which is coupled to the base by means of a first rotary joint comprising a first rotational axis according to the above aspect of the invention, and coupled to the connecting part by means of a second rotary joint comprising a second rotational axis oriented perpendicular to the first rotational axis according to the previous aspect of the invention. The first rotary joint can particularly be a rotary joint freely rotatably settable through 360°, whereas the second rotary joint is a rotary joint whose pivoting angular range has limited rotatable setting options. A component assembly designed in this manner can be used to adjust and set an angular orientation in space very precisely about one, particularly about two rotational or pivoting axes.

In another embodiment of a component assembly according to the invention, the joint formed between two elements of the component assembly, which form the joint parts, is a slide joint according to the first aspect of the invention, wherein a linear offset between the two elements of the component assembly can be defined by means of the joint positions which can be set in accordance with the first spacing pitch. Such a design allows very exact axial positioning in a fine pitch of respective abutment points or connecting points in space.

### BRIEF DESCRIPTION OF THE SEVERAL VIEWS OF THE DRAWINGS

Other advantages and characteristics of the invention can be derived from the description of an exemplary embodiment below based on the enclosed figures. Wherein:

FIG. 1 shows a view of an abutment adapter to be used in a build-up of a clamping device as a first example of a component assembly according to the invention with joints according to the invention implemented therein;

FIG. 2 shows an exploded view of the abutment adapter shown in FIG. 1;

FIG. 3 shows a view of a strut connection to be used in a build-up of a clamping device as a second example of a component assembly according to the invention with joints according to the invention implemented therein;

FIG. 4 shows an exploded view of the strut connection shown in FIG. 3; and

FIG. 5 shows an exploded view of strut connection as shown in FIG. 3 from a different viewing angle.

Exemplary embodiments in which a component assembly according to the invention can be implemented, which comprises at least one joint according to the invention, will be presented and explained below based on the enclosed figures. The exemplary embodiments shown should be considered as a mere selection of implementations of the invention, wherein an implementation of a joint according to the invention is not necessarily limited to an implementation in a component assembly as described, component assemblies of other designs can be formed which contain one or more joints according to the invention and derive advantages therefrom.

### DETAILED DESCRIPTION

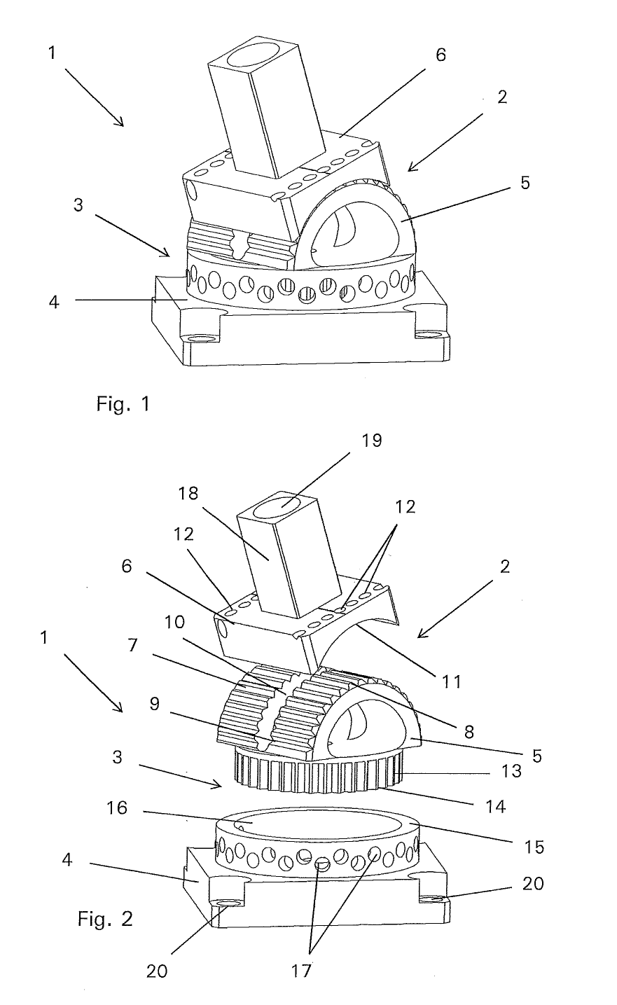

FIGS. 1 and 2 represent a first exemplary embodiment of a component assembly according to the invention having two joints designed according to the invention in the form of rotary joints. The component assembly shown is designed as an abutment adapter 1, which is used to perform an exact angular setting, optionally also an axial setting, of the precise position of an abutment or clamping point in a device for clamping workpieces, in order to position the clamping or abutment point in space in accordance with design or metrological specifications.

The abutment adapter 1 comprises overall two joints 2 and 3, on which individual joint parts are rotatably or pivotably connected. This means that the joints 2 and 3 are rotary joints. The abutment adapter 1 shown in the figures has an overall three-part design including a base 4, a central member 5 connected to the base 4 in the joint 3, and a connecting part 6 connected to the central member 5 in the joint 2. The exact composition of the abutment adapter 1 can be seen particularly well in the exploded view of FIG. 2. It is well visible there that the joint 2 formed between the central member 5 and the connecting part 6 comprises a first joint face 7, which is formed at the central member 5. This joint face 7 has the shape of a partial cylinder and extends in accordance with the circumference of a partial section of the shell surface of a circular cylinder. This first joint face 7 of the joint 2 has a structuring in the form of a toothing 8. The toothing 8 forms tooth bottoms 9, which are arranged distributed in an angular pitch at equal angular distances between adjacent tooth bottoms 9. The angular distances (in relation to a circumferential angle starting from a central axis of the circular cylinder on the shell surface of which the joint face 7 is located) can for example be 10° here. The joint face 7 is interrupted by a slot 10 extending in the circumferential direction of the cylinder shell surface. The joint face 7 is convexly shaped.

A joint face 11 having a complementary shape is formed on the connecting part 6 corresponding to the joint face 7 on the central member 5; it is accordingly concave in shape. This surface has the shape of a circular cylinder section as well, that is of a section of a circular cylinder shell surface. Holes 12 which penetrate the joint face 11 are provided in the connecting part 6. The interruptions of the joint face 11 at which the holes 12 terminate are also arranged in an even angular pitch, wherein adjacent orifices of the holes 12 along the pivoting direction have an angular distance. It should be noted at this point that—for space considerations—the holes 12 are drilled on two opposite sides of the connecting part 6, wherein the holes 12 in the row are disposed at an offset from one another, such that holes 12 which are adjacent in the angular dimension are always positioned alternately on the one side and the other side of the connecting part 6. In other words: If a first hole 12 is seen on a left side of the connecting part 6, the nearest hole 12 by an angular offset can be found on the right side of the connecting part 6, and the next hole 12 by the same angular offset will again be on the left side, and so on. The angular pitch which is formed by the holes 12 penetrating the joint face 11 can in this example be 10.5°.

The other joint 3, which is formed on the interface of the central member 5 and the base 4, comprises a first joint face 13 in the shape of a circular cylinder, which surface has a structuring in the form of a toothing 14 along its entire circumference. Again, the tooth bottoms form structures which are arranged and distributed at a regular angular pitch. The distance of adjacent tooth bottoms, that is, the angular pitch, can again be 10°. A receptacle 15, which also extends in the shape of a circular cylinder, is formed on the base 4. This receptacle 15 is defined by a circumferential wall which corresponds to a cylinder shell. A joint face 16 is formed on the inner side of this cylinder shell, which surface is shaped and dimensioned to match the joint face 13, such that the latter bears against the joint face 16 when the central member 5 is accordingly connected to the base 4. Holes 17 are drilled through the wall of the receptacle 15, which holes again penetrate the joint face 16 and terminate there at a regular angular pitch, i.e. holes 17 which are adjacent in the circumferential direction are equally spaced from one another. Once again for space consideration, holes adjacent in the circumferential direction are arranged at an offset at the level of the receptacle 15. This offset in height however is insignificant for the angular pitch and does not play a major role in the function of this joint 3, which will be described below. Once again, the angular distance of adjacent holes, i.e. the angular pitch, can be 10.5° like for the holes 12 in the connecting piece 6.

Finally, a peg 18 molded to the connecting piece 6 and having a square cross section can be seen. This peg 18 comprises a receiving hole 19. The peg 18 is used to fix an abutment member or a clamping element, which can for example be fastened on the outside to the peg 18 using a ring fitting, but it can also just as well be fixed in the receiving hole 19 using a respective fixing element. The abutment member or clamping element then forms the actual abutment point or clamping point against which a workpiece to be clamped is positioned or fixed. The peg 18 has a longitudinal design such that an abutment piece or clamping element can still be moved in the axial direction and thus provide length adjustment.

Finally, mounting holes 20 can be seen in the base 4, which are drilled through the base 4 on the four corners thereof to a base surface thereof. The mounting holes 20 typically have a spacing from one another that corresponds to a pitch in which fastening structures are provided on other components used to build a device for clamping workpieces. The base 4 and thus the abutment adapter 1 can be fastened to such a component at a position that can be selected within the framework of a pitch of the fastening structures.

The abutment adapter 1 is used, and the angular positions between the central member 5 and the base 4 and the central member 5 and the connecting part 6, respectively, are adjusted as follows:

The joint 2 can be used to set an inclination of the connecting part 6 relative to the central member 5 in that the connecting part 6 is moved or adjusted with the joint face 11 on the joint face 7 in a direction of joint movement along the circumference of the circular cylinder which is in sections defined by the joint faces 11. The interaction of the toothing 8, more specifically its tooth bottoms 9, and the holes 12, more specifically the orifices thereof in the joint face 11, now allows adjustment of the pivoting angle as predetermined by an angular pitch. Due to the difference between the two angular pitches of the tooth bottoms 9 on the one side and the orifices of the holes 12 on the other side, said difference being 0.5° in the example described above, fine adjustment of the pivoting angle to be fixed can be performed in steps of 0.5° by selecting a respective pairing of the tooth bottoms 9 and the hole 12, because a locking element, for example a fixing pin not shown in the figures, is guided through one of the holes 12 until it engages in one of the tooth bottoms, such that a maximum error in relation to the desired direction to the abutment point of 0.25° can be achieved.

Likewise, the rotation angle of the joint 3 between the base 4 and the central member 5 can be set in that, due to the interaction of the structures having different angular pitches, the tooth bottoms of the toothing 14 and the orifices of the holes 17 in the joint face 16, a joint position that can be selected in steps of 0.5° in the above numerical example is fixed as described there, in that a locking means, e.g. a locking pin, is guided through one of the holes 17 into one of the tooth bottoms of the toothing 14 and fixed there.

Instead of a pin, which can easily be detached, the holes 12 and 17, respectively, can be provided with a female thread into which a threaded pin can be screwed, the tip of which, particularly conical tip of which, engages in a matching tooth bottom and fixes the respective joint in the joint position taken up. In addition, a clamping screw can be passed through the slot 10, and this clamping screw can be firmly tightened by the mounting holes 20 to fix the connecting part 6 to the central member 5. Furthermore, the base 4 with is also securely connected to the central member to prevent axial lifting, for example by a screwed connection.

The above description has made it clear that the joints 2 and 3 formed according to the invention in the abutment adapter 1 shown can be used for very fine angular adjustment, in the numerical example in steps of 0.5°, although the angular pitches of the structures involved, the toothing 8 or 14 on the one hand and the holes 12 or 17 on the other, are much wider (in the numerical example 10° or 10.5°, respectively). In this way, a universally manufacturable element can be used for a very fine adjustment of the rotation and pivoting angle of the joints 3 and 2, respectively, can be performed, which element also does not require a particularly sophisticated manufacturing method, since the respective structurings are made with a comparatively wide pitch.

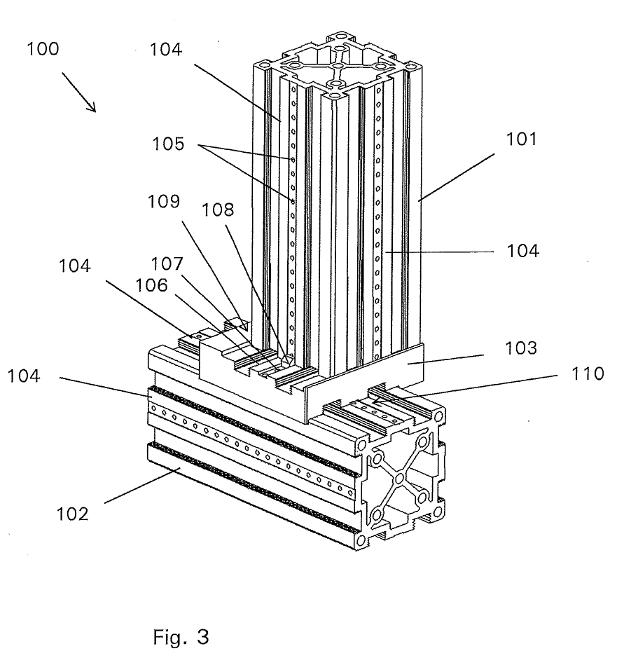

A second example of a component assembly in which joints according to the invention are implemented is shown in FIGS. 3 to 5. These show a strut connection 100 in which two cuboid struts 101, 102 are connected by means of an adapter plate 103. The struts 101, 102 comprise a central bar 104 extending in the longitudinal direction on each of their four outer surfaces which define the longitudinal sides, and these bars are laterally defined by a groove extending parallel to the bars 104. A row of holes 105, which are arranged next to one another at an equal spacing from one another, extends centrally along each of the bars 104. The spacing between two adjacent holes 105 provides a spacing pitch, which can be 10 mm.

The adapter plate 103 also comprises a bar 106 on two opposite main surfaces, which bar is defined by two grooves extending parallel to the bar 106. The adapter plate 103 also has holes 107 provided next to one another at the center of the bars 106 in the longitudinal direction, which once again are arranged at an equal spacing from one another, that is, between adjacent holes 107. This also provides a spacing pitch, and the spacing pitch of the holes 107 differs from that of the holes 105 by a difference A. The spacing pitch of the holes 107 can in this example be 10.5 mm, such that the difference A is 0.5 mm. The bars 106 on opposing main surfaces of the adapter plate 103 extend at an offset of 90° from one another.

Further visible is a mounting brace 108, which is mounted on an end face 111 of the strut 101. This mounting brace 108 also has holes 105 arranged one behind the other in its longitudinal direction and placed at the same spacing pitch, i.e. spacing from adjacent holes 105, as the holes 105 in the struts 101 and 102, respectively, in the bars 104 there. The mounting brace 108 is needed to create respective structures, that is, holes 105 at the predetermined spacing pitch, on the end face 111 of the strut 101, where no holes 105 can be provided for manufacturing reasons.

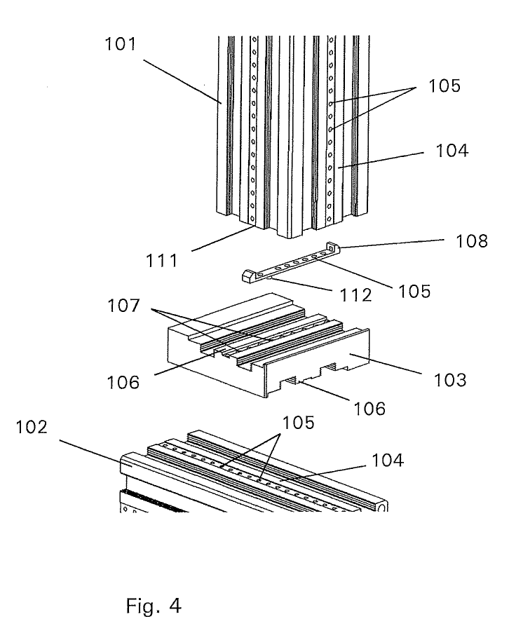

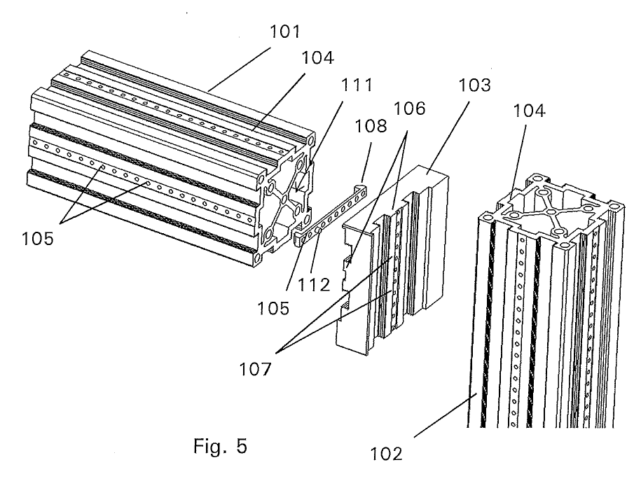

A joint 109 or 110, respectively, is formed between the adapter plate 103 and the strut 101 or strut 104, respectively, wherein these joints 109, 110 are implemented as slide joints. The involved elements, struts 101, 102, adapter plate 103 and mounting brace 108, can be firmly connected in a respective position taken up by means of a screw pin 112 outlined in FIGS. 4 and 5, which pin can be screwed into a hole 105 and into a hole 107 which is positioned flush with said hole 105, and the respective joint 109, 110 can thus be fastened in the respective joint position. The interaction of the structurings which differ in spacing pitch in the form of holes 105 and 107 results in an adjustment option in spacing steps which correspond to the amount of the difference A between the spacing pitch of the holes 105 and the spacing pitch of the holes 107, for example steps of 0.5 mm as in the numerical example above.

Since the adapter plate 103 is provided with bars 106 on opposite main surfaces which are rotated 90° to one another, the strut connection 100 can be fine adjusted along two mutually perpendicular spatial axes, for example to reach a predetermined point in space with a free end face of the strut 101 more precisely. It is apparent here that the design of the joints 109, 110 according to the invention provides the option of fine adjustment, which, starting from comparatively wide spacing pitches (10 mm and 10.5 mm, respectively) allows a very fine pitch of adjustable positions of the two struts 101 and 102 relative to one another and thus very exact positioning, for example of an abutment point or connecting position for fastening another strut or another component part in space.

### LIST OF REFERENCE SYMBOLS

1 Abutment adapter
2 Joint
3 Joint
4 Base
5 Central member
6 Connecting part
7 Joint face
8 Toothing
9 Tooth bottom
10 Slot
11 Joint face
12 Hole
13 Joint face
14 Toothing
15 Receptacle
16 Joint face
17 Hole
18 Peg
19 Receiving hole
20 Mounting hole
100 Strut connection
101 Strut
102 Strut
103 Adapter plate
104 Bar
105 Hole
106 Bar
107 Hole
108 Mounting brace
109 Joint
110 Joint
111 Front end
112 Screw pin

1. A joint that is fixable in a plurality of joint positions that are selectable in accordance with a first position pitch subdivided in equal spacing steps in a direction of joint movement, said joint having two joint parts that are displaceable relative to one another and bear against one another by way of joint faces, wherein formed on a first joint part is a first joint face which is provided with structuring that has a second position pitch subdivided into equal spacing steps in the direction of joint movement, wherein the structuring creates latch engagement points that are distributed at the second position pitch, wherein a second joint part has a second joint face and is provided with latch receptacles which interrupt the second joint face at latch positions that are arranged at a third position pitch subdivided into equal spacing steps in the direction of the direction of joint movement, wherein the second and the third position pitch are each larger than the first position pitch, wherein the first position pitch is determined by the amount of the difference between the second position pitch and the third position pitch, wherein a locking element is introducible selectively into one of the latch receptacles in a joint position taken up along the direction of joint movement of the joint, such that, from the latch position belonging to the latch receptacle, said locking element acts in such a way on a latch engagement point positioned with respect to the latch position in the joint position taken up that said locking element locks the joint in the joint position.

2. The joint according to claim 1, wherein the structuring of the first joint face is a toothing.

3. The joint according to claim 1, wherein the structuring of the first joint face is formed by holes drilled into the first joint part transversely to the first joint face according to the second position pitch.

4. The joint according to claim 1, wherein the latch receptacles are formed by holes terminating in the second joint face according to the third position pitch.

5. The joint according to claim 4, wherein the holes terminating in the second joint face penetrate through the second joint part.

6. The joint according to claim 1, wherein the joint is a rotary joint in which the two joint parts are rotatable relative to one another about a rotational axis, and in that the first, second, and third position pitches each are an angular pitch.

7. The joint according to claim 6, wherein the joint faces have a shape of a circular cylinder or a circular cylinder section.

8. The joint according to claim 7, wherein the first joint face is a convex joint face and the second joint face is a concave joint face.

9. The joint according to claim 1, wherein the joint is a slide joint in which the two joint parts are movable linearly relative to one another in a direction of joint movement, and in that the first, second, and third position pitches each are a spacing pitch.

10. A component assembly to be used for building a clamping device for workpieces, wherein said component assembly comprises a joint according to claim 1 for setting and fixing an orientation of connecting points to be positioned in the clamping device using the component assembly.

11. The component assembly according to claim 10, wherein said component assembly has the form of an abutment member comprising a base for connecting with a structural member of the clamping device and a connecting part for an abutment or clamping element, and settable at an angle for forming a workpiece support in the clamping device, wherein at least one joint that is formed as a rotary joint is provided between the base and the connecting part.

12. The component assembly according to claim 11, wherein the joint is a rotary joint in which the two joint parts are rotatable relative to one another about a rotational axis, and in that the first, second, and third position pitches each are an angular pitch; and wherein the component assembly further comprising a central member between the base and the connecting part, wherein the central member is coupled to the base by means of a first rotary joint having a first rotational axis, and the central member is coupled to the connecting part by means of a second rotary joint having a second rotational axis oriented perpendicular to the first rotational axis.

13. The component assembly according to claim 12, wherein the first rotary joint is a rotary joint freely rotatably settable through 360°.

14. The component assembly according to claim 12, wherein the second rotary joint is a rotary joint whose pivoting angular range has limited rotatable setting options.

15. The component assembly according to claim 10, wherein the joint formed between two elements of the component assembly, which form the joint parts, is a slide joint wherein a linear offset between the two elements of the component assembly is defined by the joint positions which are settable in accordance with the first spacing pitch.
